(19) United States
(12) Patent Application Publication
(10) Pub. No.: US 2026/0204899 A1
(43) Pub. Date: Jul. 16, 2026

(54) RECREATIONAL VEHICLE SURGE PROTECTION DEVICE

(71) Applicant: Hughes Autoformers LLC, Anaheim, CA (US)

(72) Inventor: Patrick Allan Thomas, Yorba Linda, CA (US)

(21) Appl. No.: 19/024,562

(22) Filed: Jan. 16, 2025

(51) Int. Cl. H02H 9/04; B60R 16/03

(52) U.S. Cl. CPC H02H 9/044; B60R 16/03

(57) ABSTRACT

A surge protection device for a recreational vehicle includes a housing having a first end, an opposing second end, and a longitudinal axis extending between the first and second ends, an electrical connector in connection with the first end and configured to couple to a power outlet, a power receptacle provided at the second end and configured to form an electrical connection with an external plug, a door movably coupled to the second end and at least partially defining an interior space and an aperture, where the interior space is configured to receive the external plug when the door is in a first position, and the door and the housing are configured to encapsulate a first portion of the external plug when the door is in a second position.

### FIELD OF THE DISCLOSURE

The present disclosure generally relates to the field of power monitoring devices and/or power conditioning devices, and specifically to surge protection devices for recreational vehicles.

### BACKGROUND OF THE DISCLOSURE

An electrical connection to an external power source is required for most recreational vehicles (RVs) in order to utilize vehicular electrical appliances without running or draining the battery of the vehicle. For example, a camping site at a campground may be furnished with a power outlet for the electrical connection. Like many electrical devices and components, an RV connected to an external power outlet is susceptible to power surges and general fluctuations in voltage levels, which can harm the RV and the electrical appliances and components therein.

To guard against damage and/or improve the performance of electrical appliances subject to dynamic voltage levels, voltage surge guard and power conditioning devices (together, “surge protectors”) are commonly used. An RV owner may interpose the connection between the RV and an external power outlet with a surge protector. This presents new challenges, as surge protectors may be relatively large, bulky, and/or unbalanced based on the geometry of the surge protector and the location of the electrical connections between the surge protector, the external power outlet, and the RV. Such attributes may increase wear on the surge protector, increase the risk of disconnection of the surge protector from the external power outlet, and/or generally lead to cumbersome operation. There is therefore a need for improved characteristics and features of movable surge protectors, particularly those for RVs.

### SUMMARY OF THE DISLOSURE

One embodiment as shown and described herein includes a surge protection device for a recreational vehicle that includes a housing having a first end, an opposing second end, and a longitudinal axis extending between the first and second ends, an electrical connector in connection with the first end of the housing and configured to couple to a power outlet, a power receptacle provided at the second end of the electrical housing, wherein the power receptacle and the electrical connector are electrically connected, and wherein the power receptacle is configured to form an electrical connection with an external plug, and a surge protection module provided in the housing and electrically interposing the electrical connector and the power receptacle, wherein the surge protection module is configured to divert power from the power outlet away from the power receptacle in response to a predetermined electrical input. The embodiment further includes a door movably coupled to the second end of the electrical housing, the door at least partially defining an interior space and an aperture, wherein the door is movable between a first position and a second position, wherein the interior space is configured to receive the external plug when the door is in the first position, wherein the door and the housing are configured to encapsulate a first portion of the external plug when the door is in the second position, wherein the aperture is configured to surround the external plug in the second position, and wherein the door in the second position is configured to prevent the external plug from decoupling from the power receptacle when the external plug is coupled to the power receptacle.

Another embodiment as shown and described herein may further or alternatively include a surge protection device for a recreational vehicle that includes a housing having a first end, a second end, and a longitudinal axis extending between the first and second ends, an electrical connector in connection with the first end of the housing and configured to couple to a power outlet, a power receptacle located at the second end of the housing and configured to receive an external plug, an electrical pathway provided in the housing, the electrical pathway connecting the electrical connector and the power receptacle, and a surge protection module provided in the housing and along the electrical pathway between the electrical connector and the power receptacle, wherein the surge protection module is configured to divert power from the electrical pathway in response to a predetermined electrical input. The embodiment further includes a door operably coupled to the second end of the housing and pivotal between an open first position and a closed second position, wherein the door defines at least part of an interior space configured to receive part of the external plug when the door is in the second position and the external plug is coupled to the power receptacle, wherein the electrical connector is connected to the housing at a location substantially along the longitudinal axis, and wherein the power receptacle is located substantially along the longitudinal axis.

Another embodiment as shown and described herein may further or alternatively include a surge protection device for a recreational vehicle that includes a housing having a first end, an opposing second end, and a longitudinal axis extending between the first and second ends, an electrical connector in connection with the first end of the housing proximate the longitudinal axis and configured to couple to a power outlet, wherein the electrical connector is connected to the housing at a location substantially along the longitudinal axis, a power receptacle located at the second end of the housing substantially along the longitudinal axis and configured to receive an external plug, wherein the power receptacle is in electrical communication with the electrical connector, and a surge protection module located in the housing and electrically interposing the electrical connector and the power receptacle, wherein the surge protection module is configured to divert power from the power outlet in response to detecting a predetermined electrical input. The embodiment further includes a door pivotally coupled to the second end of the housing, wherein the door is pivotal between an open position where the door is configured to allow the external plug to couple to and decouple from the power receptacle and a closed position where the door is configured to prevent the external plug from decoupling from the power receptacle when the external plug is received by the power receptacle, and wherein the door at least partially defines an aperture located proximate the longitudinal axis and through which the external plug extends when the external plug is received by the power receptacle and the door is in the closed position.

Yet another embodiment as shown and described herein further or alternatively includes a surge protection device for a recreational vehicle that includes a housing, an electrical connector in connection with the housing and configured to couple to a power outlet, a power receptacle provided on the electrical housing, wherein the power receptacle and the electrical connector are electrically connected, and wherein the power receptacle is configured to form an electrical connection with an external plug, a surge protection module provided in the housing and electrically interposing the electrical connector and the power receptacle, wherein the surge protection module is configured to divert power from the power outlet away from the power receptacle in response to a predetermined electrical input, and a door movably coupled to the electrical housing between a first position where the external plug may be coupled with and uncoupled from the power receptacle and a second position where the external plug is prevented from being uncoupled from the power receptacle, wherein the door and the housing are configured to at least partially encapsulate the external plug when the door is in the second position, and wherein the door is configured to receive a separate locking device configured to secure the door in the second position.

These and other features, advantages, and objects of the present disclosure will be further understood and appreciated by those skilled in the art by reference to the following specification, claims, and appended drawings.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1A is a perspective view of a surge protection device in connection with an external plug of an electrical component, where the surge protection device includes a door in an open position;

FIG. 1B is a schematic view of the surge protection device connected to a power outlet and the external plug of the electrical component;

FIG. 2 is a perspective view of the surge protection device in connection with the external plug of the electrical component, wherein the door is in a closed position; and

FIG. 3 is an exploded view of a connection between the door and the housing of the surge protection device.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

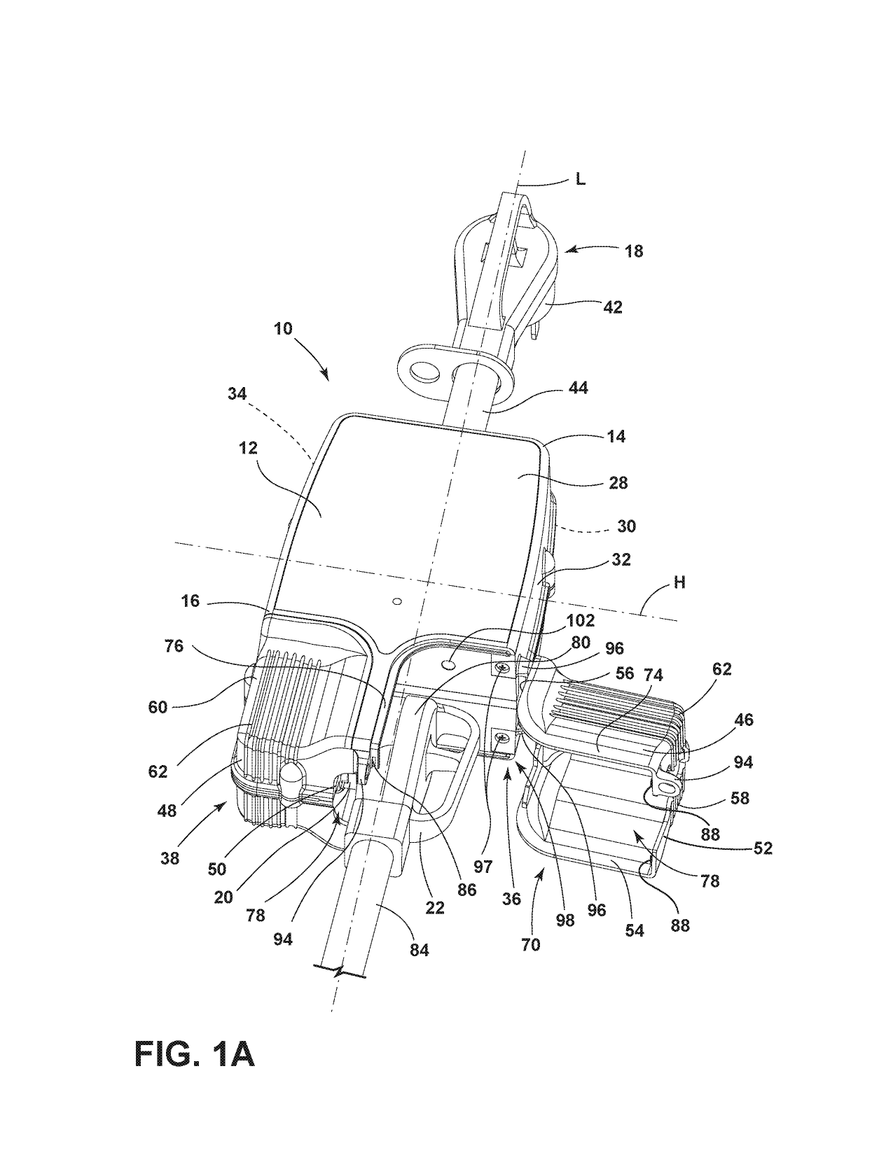

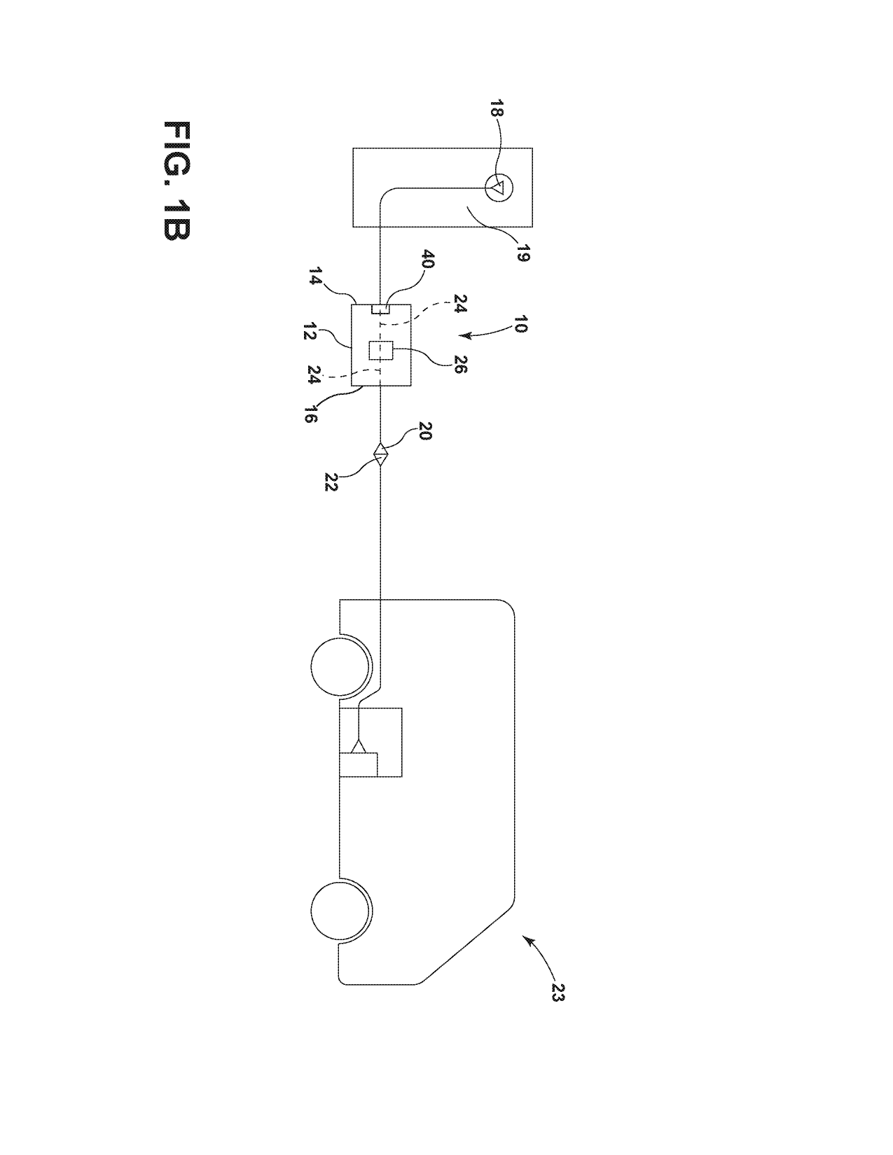

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a surge protection device. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Electrical devices that protect electrical appliances and components against dynamic voltage levels are known by names such as surge protectors, power conditioners, and power monitoring devices. Such electrical devices will hereinafter be referred to as “surge protection devices.”

Referring initially to FIGS. 1A and 1B, reference numeral 10 generally designates a surge protection device. The surge protection device 10 includes a housing 12 with a first end 14, an opposing second end 16, and a longitudinal axis L extending between the ends 14, 16. An electrical connector 18 further extends from the first end 14 of the housing 12 along the longitudinal axis L. The electrical connector 18 is configured to connect to a power outlet, a power source, or another electrical component configured to supply electrical power to the surge protection device 10 (hereinafter “power outlet 19”). A power receptacle 20 is provided at the second end 16 of the housing 12, where the power receptacle 20 is configured to couple and electrically connect to an external plug 22 of an electrical component 23, such as an RV or an electrical appliance therein. The power receptacle 20 is in electrical communication with the electrical connector 18 via an electrical pathway 24 provided within the housing 12, wherein a surge protection module 26 interposes the electrical connector 18 and the power receptacle 20 along the electrical pathway 24. Both the electrical pathway 24 and the surge protection module 26 are disposed within the housing 12. Notably, the housing 12 may contain several other electronic components, such as sensors, processor(s), integrated circuits, a wireless communication module, an electronic structure for processing, transmitting and receiving wireless signals, a Liquid Crystal Display (LCD), and/or other electronic components.

The first and second ends 14, 16 of the housing 12 are connected by a pair of face surfaces 28, 30 and a pair of side surfaces 32, 34. The face and side surfaces 28, 30, 32, 34 of the housing 12 extend substantially parallel between the first and second ends 14, 16 of the housing 12, and the pair of side surfaces 32, 34 define first and second sides 36, 38 of the housing 12. The housing 12 of the surge protection device 10 is substantially symmetrical across the longitudinal axis L and a lateral axis H. Therefore, the surge protection device 10 is effectively balanced when the electrical connector 18 is coupled to the power outlet 19 and the power receptacle 20 is coupled to the electrical component 23. Notably, alternative housing geometries are contemplated to balance the surge protection device 10, which may also depend on where the electrical connector 18 and the power receptacle 20 are connected to the housing 12. Additionally, the housing 12 may be made using a material including but not limited to plastic.

The surge protection device 10 includes the surge protection module 26, which is configured to protect downstream electrical appliances from inconsistent power input, predetermined electrical inputs or conditions such as voltage spikes, faulty ground, open neutral, and the like, as further discussed below. The surge protection module 26 is in electrical communication with the electrical pathway 24 between the electrical connector 18 and the power receptacle 20. When the electrical connector 18 is in connection with the power outlet 19, which may be an RV park power outlet, electrical energy from the power outlet 19 flows from the electrical connector 18 and through the electrical pathway 24 before reaching the power receptacle 20 and the electrical component 23 in electrical connection with the power receptacle 20, or alternatively may involve or include unsafe electrical conditions present in the electrical system of the RV. By way of example, any inconsistent power input, such as voltage spikes, reaches the surge protection module 26 before reaching the power receptacle 20. The surge protection module 26 may have a predetermined threshold voltage value such that the surge protection module 26 may divert at least a portion of excess current from the electrical pathway 24 in response to the voltage across the surge protection module 26 exceeding the predetermined threshold voltage value. It is to be understood that other types of power conditioners can alternatively or additionally be included within the housing 12.

An electrical circuit that includes the power outlet 19, electrical connector 18, the power receptacle 20, and the external plug 22 of the electrical component 23 may further include a power monitoring module 40 configured to sense one or more energy parameters of the input power, thereby providing the surge protection device 10 with monitoring capabilities such as determining whether electricity is flowing through the power receptacle 20 to the electrical component 23, the status of ground structures, and/or electricity flow parameters such as voltage, current (amps), energy usage (joules) and power draw (watts). The power monitoring module 40 may further include processing abilities capable of analyzing said measurements, calculating parameters, tracking parameters, and/or saving said parameters into a memory component. Hence, in accordance with the present invention, the details of U.S. Patent No. 11,128,934, titled “Recreational Vehicle Power Monitor and Reporting Device and Method,” are herein incorporated by reference in whole. U.S. Patent No. 11,128,934 provides relevant background and additional aspects of devices for protecting external appliances from problems with shore power, monitoring and conditioning shore power delivered to a user’s RV, and communicating related information to the user of the RV in a convenient and usable manner. Additionally, the referenced patent discloses technology and methodologies that may be incorporated, adapted, or further developed in the present disclosure to achieve the objectives described herein. Where applicable, the teachings and embodiments disclosed in U.S. Patent No. 11,128,934 are compatible with and may enhance the features and functionality of the surge protection device 10 as described in the current specification. Any inconsistencies between the incorporated reference and this application shall be resolved in favor of the present disclosure.

Referring further to FIGS. 1A and 1B, the electrical connector 18 extends from the first end 14 of the housing 12 along the longitudinal axis L, where the electrical connector 18 is configured to connect to the power outlet 19. The electrical connector 18 includes a three-pronged plug 42 and a 10 American Wire Gauge (AWG) wire 44 connected to the first side 36 of the housing 12. The wire 44 has a length, as defined between the plug 42 and the first end 14 of the housing 12, less than a length of the housing 12. Notwithstanding the current parameters of the plug 42 and the wire 44, in alternative embodiments, the plug 42 of the surge protection device 10 may be a two-prong, three-prong, or four-prong plug capable of supporting 15-Amp appliances, 20-Amp appliances, 30-Amp appliances, and/or 50-Amp appliances. Furthermore, depending on the types and power draws of electrical components 23 desired to be supported by the surge protection device 10, wires having wire gauges including but not limited to 14 AWG, 12 AWG, and 8 AWG wire may be used. It is contemplated that the electrical connector 18 may connect to the power outlet 19 with other means, such as through direct wiring. The plug 42 of the electrical connector 18 may be coupled to the housing 12 without the wire 44 interposing the housing 12 and the plug 42. Alternatively, the wire 44 may have a length greater than the length of the housing 12.

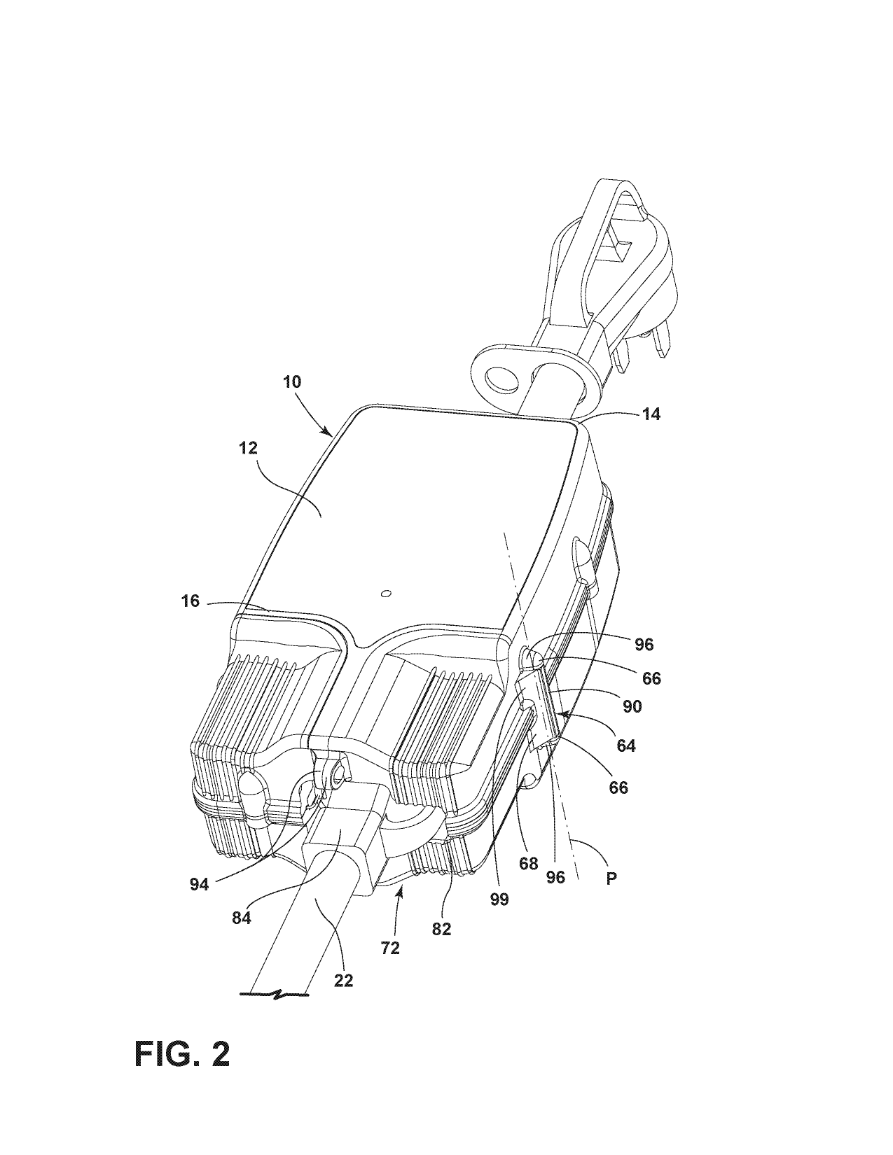

With reference now to FIGS. 1A and 2, the second end 16 of the housing 12 defines the first side 36 and the second side 38, where the pair of face surfaces 28, 30 extend between the first and second sides 36, 38, and the pair of side surfaces 32, 34 further define the first and second sides 36, 38. A door 46 having a clamshell shape is pivotally coupled to the housing 12 proximate the first side 36 of the second end 16, and a door-shaped protrusion 48 extends from the housing 12 proximate the second side 38 of the second end 16. The power receptacle 20 is disposed on an intermediate surface 50 of the protrusion 48. In effect, the power receptacle 20 interposes the first and second sides 36, 38, and the power receptacle 20 is configured to receive the external plug 22 along an axis substantially perpendicular to the longitudinal axis L of the housing 12. In alternative embodiments, the power receptacle 20 may be located at the second end 16 of the housing 12, interposing the first and second sides 36, 38, where the power receptacle 20 is configured to receive the external plug 22 along an axis substantially parallel to the longitudinal axis L of the housing 12. In such embodiments, it is contemplated that the surge protection device 10 may further include a second door situated in the position of the protrusion 48, where the second door is substituted for the protrusion 48, and where the second door is pivotally coupled to the housing 12 proximate the second side 38 of the second end 16. The preferability of each of these alternative embodiments ultimately depends on the use case of the surge protection device 10 and the type of external plug 22 expected to connect to the power receptacle 20.

The surge protection device 10 includes the door 46 which is pivotally coupled proximate the first side 36 of the second end 16 of the housing 12. The door 46 has an outer surface 52, an inner surface 54, a base end 56, and a free end 58, and the outer surface 52 of the door 46 and an outer surface 60 of the protrusion 48 each have a plurality of elongate gripping features 62 for increased convenience during use of the surge protection device 10. The door 46 is further pivotal with respect to the housing 12 at the base end 56 via a hinge 64. The hinge 64 includes a first hinge component 66 coupled to the housing 12 at a first side surface 32 proximate the second end 16. The hinge 64 also includes a second hinge component 68 disposed at the base end 56 of the door 46. The first and second hinge components 66, 68 are pivotally coupled such that the door 46 and the housing 12 are pivotally coupled. Furthermore, the door 46 is pivotal between an open position 70 (FIG. 1A) and a closed position 72 (FIG. 2). The door 46 has a lip 74 configured to contact the intermediate surface 50 of the protrusion 48 and the second end 16 of the housing 12 between the intermediate surface 50 and the first end 14 when the door 46 is in the closed position 72. When the door 46 is in the closed position 72, and the lip 74 of the door 46 contacts the intermediate surface 50 of the protrusion 48 and the second end 16 of the housing 12, the pair of face surfaces 28, 30 and the pair of side surfaces 32, 34 of the housing 12 are substantially continuous. When the door 46 is in the open position 70, the lip 74 of the door 46 is not in contact with the intermediate surface 50 of the protrusion 48 and the second end 16 of the housing 12, and the pair of face surfaces 28, 30 and the pair of side surfaces 32, 34 of the housing 12 are discontinuous. The intermediate surface 50 further includes a raised rim 76, where the lip 74 of the door 46 couples to the rim 76 of the intermediate surface 50 when the door 46 is in the closed position 72. In the exemplary embodiment, the lip 74 runs along the door 46 from the free end 58 to the base end 56. The rim 76 runs along the intermediate surface 50 and the second end 16 of the housing 12 between the intermediate surface 50 and the first end 14, complementing the lip 74 of the door 46. However, it is contemplated that the lip 74 of the door 46 may be configured to contact the rim 76 of the intermediate surface 50 proximate the free end 58 of the door 46 only.

Still referring to FIG. 2, the door 46 is in the closed position 72, and both the door 46 and the protrusion 48 of the housing 12 partially define an interior space 78. The power receptacle 20 is provided within the interior space 78, and the external plug 22 is received by the power receptacle 20. Accordingly, a first portion 80 of the external plug 22 is received by the interior space 78. When the first portion 80 of the external plug 22 is received by the interior space 78, the first portion 80 of the external plug 22 is substantially encapsulated by a combination of the protrusion 48 of the housing 12 and the door 46, thereby being protected from conditions exterior to the surge protection device 10. In other embodiments, the interior space 78 may be primarily defined by an alternate combination of the protrusion 48 and the door 46. For example, the interior space 78 may be wholly defined by the protrusion 48, wholly defined by the door 46, or defined by different combination of the protrusion 48 and the door 46 than is provided in the embodiment depicted in FIG. 2.

An aperture 82 is further partially defined by the door 46 and the protrusion 48 of the housing 12 such that contact between the lip 74 of the door 46 and the rim 76 of the intermediate surface 50 is interrupted. The aperture 82 extends substantially perpendicular to the longitudinal axis L of the housing 12. More specifically, the aperture 82 is substantially aligned with the longitudinal axis L such that, when the door is in the closed position 72, the first portion 80 of the external plug 22 may be received by the interior space 78 and a second portion 84 of the external plug 22 may extend away from the surge protection device 10. As a result, the external plug 22 can maintain an electrical connection with the power receptacle 20 irrespective of the position of the door 46. The aperture 82 consequently surrounds the external plug 22 and demarcates the first and second portions 80, 84 of the external plug 22. The aperture 82 is further shaped to generally align with a cross section of the external plug 22 identified at the demarcation of the first and second portions 80, 84 and orthogonal to the longitudinal axis L of the housing 12. Thus, the aperture 82 can provide improved protection for the first portion 80 of the external plug 22 from the conditions exterior to the surge protection device 10 when the external plug 22 is in electrical connection with the power receptacle 20. Importantly, the location of the aperture 82 relative to the door 46 may vary based on the type of external plug 22 that is intended to be received by the power receptacle 20. The aperture 82 may also be defined by an alternate combination of the door 46 and the protrusion 48. For example, the aperture 82 may be wholly defined by the door 46, wholly defined by the protrusion 48, or defined by a different combination of the door 46 and the protrusion 48 in other embodiments. Preferably, however, the aperture 82 is defined by a combination of the door 46 and the housing 12 so as to best protect the first portion 80 from conditions exterior to the surge protection device 10 when the external plug 22 is in electrical connection with the power receptacle 20. It is also contemplated that the shape and/or size of the aperture 82 may vary. Preferably, the aperture 82 defines an area configured to prohibit the decoupling of the power receptacle 20 and the external plug 22 when the door 46 is in the closed position 72 and when the external plug 22 is in electrical connection with the power receptacle 20. Moreover, the shape and/or size of the interior space 78 may vary. Preferably, the interior space 78 defines a volume configured to prohibit the decoupling of the power receptacle 20 and the external plug 22 when the door 46 is in the closed position 72 and when the external plug 22 is in electrical connection with the power receptacle 20.

With reference to FIGS. 1 and 2, the door 46 is pivotal between the open and closed positions 70, 72 about a pivot axis P that is perpendicular to the longitudinal axis L of the housing 12 and situated at the first side surface 32 proximate the first side 36 of the second end 16. When the door 46 pivots into the closed position 72 from another position, the door 46 is pivoted toward the protrusion 48 of the housing 12. In the closed position 72, the door 46 is coupled to the protrusion 48 of the housing 12, and the lip 74 of the door 46 is coupled to the rim 76 of the intermediate surface 50, thereby defining the interior space 78, aligning portions of the aperture 82, and aligning the outer surfaces 52, 60 of the door 46 and the protrusion 48. When the door 46 is in the closed position 72, the distance that both the protrusion 48 and the door 46 extend from the second end 16 of the housing 12 is substantially equal, and the distance that both the protrusion 48 and the door 46 extend from the longitudinal axis L of the housing 12 is substantially equal, thereby balancing the surge protection device 10. When the door 46 is in the closed position 72, and the external plug 22 is coupled to the power receptacle 20 within the interior space 78, the external plug 22 is prevented from decoupling from the power receptacle 20 unless the door 46 is pivoted into the open position 70. When the external plug 22 is not within the interior space 78, the external plug 22 is prevented from entering into the interior space 78 through the aperture 82 and connecting to the power receptacle 20 when the door 46 is in the closed position 72.

When the door 46 pivots from the closed position 72 to the open position 70, the lip 74 of the door 46 decouples from the rim 76 of the intermediate surface 50, and the door 46 is pivoted away from the protrusion 48 and the second end 16 of the housing 12 between the intermediate surface 50 and the first end 14, disrupting the alignment of the portions of the aperture 82, the portions of the interior space 78, and the outer surfaces 52, 60 of the door 46 and the protrusion 48. When the door 46 is in the open position 70, the door 46 and the protrusion 48 are separated at a distance that allows the external plug 22 to couple to and decouple from the power receptacle 20. The external plug 22 is configured to couple to and decouple from the power receptacle 20 along an axis that is substantially perpendicular to the longitudinal axis L of the housing 12.

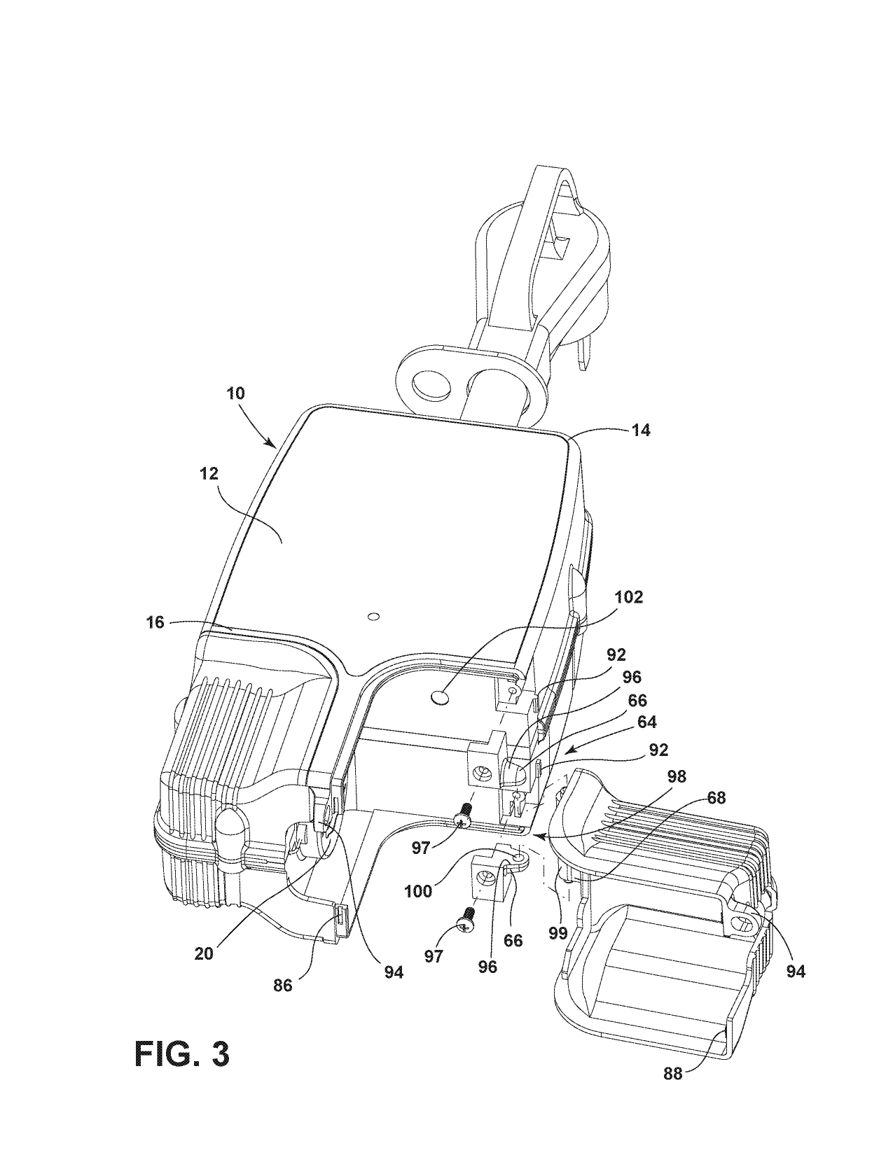

With reference now to FIGS. 2-3, the door 46 of the surge protection device 10 includes at least one securement mechanism configured to yieldingly hold the door 46 in the closed position 72. The rim 76 of the intermediate surface 50 in the current embodiment defines a notch 86 configured to receive a projection 88 extending from the inner surface 54 of the door 46, providing a snap-fit connection (FIG. 3). In alternative embodiments, the notch 86 may extend along the lip 74 and, consequently, further along the interface between the door 46 and the intermediate surface 50. The door 46 is further equipped with a retaining feature configured to yieldingly hold the door 46 in the open position 70. Particularly, the retaining feature is configured to yieldingly couple the door 46 to the housing 12 at the first side surface 32 proximate the second end 16. In the exemplified embodiment, the retaining feature is a rib 90 provided on the second hinge component 68 extending from the door 46. When the door 46 pivots from another position into the open position 70, the rib 90 slides over a pair of raised tabs 92 extending from the first side surface 32 of the housing 12, providing a snap-fit coupling between the door 46 and the first side surface 32. Additionally, both the door 46 and the protrusion 48 of the housing 12 have a hasp 94 configured to receive an external locking member. The hasps 94 of the door 46 and the protrusion 48 are configured to align when the door 46 is in the closed position 72, and the external locking member can in turn lock the door 46 to the protrusion 48 in the closed position 72. It is contemplated that similar locking engagements other than the hasps 94 can be utilized in the surge protection device 10 for the purpose of locking the door 46 in the closed position 72.

Referring now to FIG. 3, the first hinge component 66 is a pair of hinge prongs 96 removably secured with fasteners 97 to a corner 98 connecting the first side surface 32 of the housing 12 and the second end 16 of the housing 12. The pair of hinge prongs 96 extend from the first side surface 32 proximate the second end 16, and the hinge prongs 96 are disposed along the pivot axis P. The second hinge component 68 is a pivot pin 99 extending from the door 46. Each of the pair of hinge prongs 96 define a cavity 100, and the pivot pin 99 is pivotal between the pair of hinge prongs 96 and within the cavities 100 about the pivot axis P. Notably, the hinge 64 may comprise a different configuration in other embodiments. For example, the hinge 64 may resemble a common door hinge, barrel hinge, pin hinge, piano hinge, spring hinge, T hinge, strap hinge, or a stop hinge, among other hinge types. Notably, the pivot pin 99 of the door 46 is removably coupled to the pair of hinge prongs 96, as the hinge 64 is configured to receive a replacement door having a different dimension such that the replacement door is pivotally coupled to the housing 12. To remove the door 46, the fasteners 97 coupling the hinge prongs 96 to the housing 12 are unfastened, thereby decoupling the hinge prongs 96 from the housing 12. Thereafter, the door 46 can be removed, and the replacement door can be pivotally coupled to the housing 12 via the hinge 64. The surge protection device 10 may include additional doors with a variety of dimensions and configurations, such as those defining the aperture 82 in a different location.

With further reference to FIG. 3, the surge protection device 10 further includes a light 102 disposed at the second end 16 of the housing 12 between the intermediate surface 50 and the first side 36. The light 102 is configured to illuminate the interior space 78 and the power receptacle 20, enabling a user to connect the external plug 22 of the electrical component 23 to the power receptacle 20 in dimly lit environments. The light 102 may also illuminate the door 46, the protrusion 48 of the housing 12, and the external plug 22 proximate the interior space 78 when the door 46 is in the open position 70, further optically assisting the user. In alternative embodiments, the door 46 may be semi-transparent or transparent, allowing the light 102 to be seen through the door 46 when the door 46 is in the closed position 72. Notably, with further reference to U.S. Patent No. 11,128,934, titled “Recreational Vehicle Power Monitor and Reporting Device and Method,” the light 102 may also indicate, with an assortment of colors, a live connection to a power supply, a power supply missing a neutral, a line voltage error, an overcurrent error, a line and neutral reversed error, that the surge protection module 26 is used up, and/or a line frequency error. The light 102 may further illuminate a graphic or serve as a night light and deterrent against thieves or other bad actors. Notably, the location of the light 102 on the housing 12 is variable. For example, the light 102 may be disposed on the protrusion 48 or the inner surface 54 of the door 46. The surge protection device 10 may also include additional lights similarly configured to illuminate and/or indicate messages.

The surge protection device 10 described in the present disclosure provides multiple advantages over previously known devices. For example, the surge protection device 10 provides cutting-edge geometry that not only appeals to the consumer, but introduces an improved balancing of the device 10, thereby decreasing wear on the surge protection device 10, the power outlet 19 to which the surge protection device 10 is coupled, and any electrical component 23 coupled to the surge protection device 10. Moreover, the design of the surge protection device 10 minimizes fluid ingress into the interior space 78 when the door 46 is in the closed position 72, which may also decrease the risk of wear and damage to the device 10 and to the electrical component 23. The surge protection device 10 further increases convenience during use with the light 102, which may allow a user to quickly and conveniently couple or decouple the electrical component 23 to or from the power receptacle 20, respectively.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A surge protection device for a recreational vehicle, comprising:
a housing having a first end, an opposing second end, and a longitudinal axis extending between the first and second ends;
an electrical connector in connection with the first end of the housing and configured to couple to a power outlet;
a power receptacle provided at the second end of the electrical housing, wherein the power receptacle and the electrical connector are electrically connected, and wherein the power receptacle is configured to form an electrical connection with an external plug;
a surge protection module provided in the housing and electrically interposing the electrical connector and the power receptacle, wherein the surge protection module is configured to divert power from the power outlet away from the power receptacle in response to a predetermined electrical input; and
a door movably coupled to the second end of the electrical housing, the door at least partially defining an interior space and an aperture;
wherein the door is movable between a first position and a second position,
wherein the interior space is configured to receive the external plug when the door is in the first position,
wherein the door and the housing are configured to encapsulate a first portion of the external plug when the door is in the second position,
wherein the aperture is configured to surround the external plug in the second position, and
wherein the door in the second position is configured to prevent the external plug from decoupling from the power receptacle when the external plug is coupled to the power receptacle.

2. The surge protection device of claim 1, wherein the door is pivotally coupled to the second end of the housing.

3. The surge protection device of claim 1, wherein the door is configured to receive a separate locking device configured to secure the door in the second position.

4. The surge protection device of claim 1, wherein the door is configured to yieldingly couple to the second end of the electrical housing when the door is in the second position.

5. The surge protection device of claim 1, wherein the aperture is provided substantially along the longitudinal axis of the housing.

6. The surge protection device of claim 5, wherein the power receptacle is provided substantially along the longitudinal axis of the housing.

7. The surge protection device of claim 6, wherein the electrical connector extends from the housing substantially along the longitudinal axis.

8. The surge protection device of claim 1, wherein the door is removably coupled to a hinge provided proximate a first side of the second end of the housing, wherein the hinge is configured to pivotally couple to a door with a different dimension.

9. The surge protection device of claim 1, further comprising:
a light proximate the power receptacle and configured to illuminate the power receptacle.

10. The surge protection device of claim 9, wherein the light is provided within the interior space when the door is in the second position.

11. The surge protection device of claim 1, wherein the predetermined electrical input includes a voltage provided from the power outlet exceeding a predetermined threshold voltage.

12. A surge protection device for a recreational vehicle, comprising:
a housing having a first end, a second end, and a longitudinal axis extending between the first and second ends;
an electrical connector in connection with the first end of the housing and configured to couple to a power outlet;
a power receptacle located at the second end of the housing and configured to receive an external plug;
an electrical pathway provided in the housing, the electrical pathway connecting the electrical connector and the power receptacle;
a surge protection module provided in the housing and along the electrical pathway between the electrical connector and the power receptacle, wherein the surge protection module is configured to divert power from the electrical pathway in response to a predetermined electrical input; and
a door operably coupled to the second end of the housing and pivotal between an open first position and a closed second position;
wherein the door defines at least part of an interior space configured to receive part of the external plug when the door is in the second position and the external plug is coupled to the power receptacle,
wherein the electrical connector is connected to the housing at a location substantially along the longitudinal axis, and
wherein the power receptacle is located substantially along the longitudinal axis.

13. The surge protection device of claim 12, wherein the door at least partially defines an aperture through which the external plug extends when the door is in the second position and the external plug is received by the power receptacle.

14. The surge protection device for a recreational vehicle of claim 12, wherein the door is removably coupled to a hinge at the second end of the housing, the hinge being configured to removably couple to a door with a different dimension.

15. The surge protection device of claim 12, further comprising:
a fastening mechanism located proximate the second end of the housing, wherein the fastening mechanism is configured to hold the door in place in the second position.

16. The surge protection device of claim 12, further comprising:
a light coupled to the housing and located proximate the power receptacle.

17. The surge protection device of claim 12, wherein the door in the first position is configured to allow the external plug to couple to and decouple from the power receptacle, and
wherein the door in the second position is configured to prevent the external plug from decoupling from the power receptacle when the external plug is received by the power receptacle.

18. The surge protection device of claim 12, wherein the predetermined electrical input includes a voltage provided from the power outlet exceeding a predetermined threshold voltage.

19. The surge protection device of claim 12, wherein the door is pivotally coupled to the housing.

20. A surge protection device for a recreational vehicle, comprising:
a housing having a first end, an opposing second end, and a longitudinal axis extending between the first and second ends;
an electrical connector in connection with the first end of the housing proximate the longitudinal axis and configured to couple to a power outlet, wherein the electrical connector is connected to the housing at a location substantially along the longitudinal axis;
a power receptacle located at the second end of the housing substantially along the longitudinal axis and configured to receive an external plug, wherein the power receptacle is in electrical communication with the electrical connector;
a surge protection module located in the housing and electrically interposing the electrical connector and the power receptacle, wherein the surge protection module is configured to divert power from the power outlet in response to detecting a predetermined electrical input; and
a door pivotally coupled to the second end of the housing, wherein the door is pivotal between an open position where the door is configured to allow the external plug to couple to and decouple from the power receptacle and a closed position where the door is configured to prevent the external plug from decoupling from the power receptacle when the external plug is received by the power receptacle;
wherein the door at least partially defines an aperture located proximate the longitudinal axis and through which the external plug extends when the external plug is received by the power receptacle and the door is in the closed position.

21. The surge protection device of claim 20, wherein the aperture, power receptacle, and the connection between the housing and the electrical connector are provided along the longitudinal axis of the housing.

22. The surge protection device of claim 20, wherein the door is configured to receive a locking mechanism for securing the door in the closed position.

23. The surge protection device of claim 20, wherein the door is removably secured to a hinge located at the second end of the housing, the hinge being configured to removably couple to a door with a different dimension.

24. The surge protection device of claim 20, further comprising:
a light proximate the power receptacle and encapsulated between the door and the housing when the door is in the closed position.

25. The surge protection device of claim 20, wherein the predetermined electrical input includes a voltage provided from the power outlet exceeding a predetermined threshold voltage.

26. A surge protection device for a recreational vehicle, comprising:
a housing;
an electrical connector in connection with the housing and configured to couple to a power outlet;
a power receptacle provided on the electrical housing, wherein the power receptacle and the electrical connector are electrically connected, and wherein the power receptacle is configured to form an electrical connection with an external plug;
a surge protection module provided in the housing and electrically interposing the electrical connector and the power receptacle, wherein the surge protection module is configured to divert power from the power outlet away from the power receptacle in response to a predetermined electrical input; and
a door movably coupled to the electrical housing between a first position where the external plug may be coupled with and uncoupled from the power receptacle and a second position where the external plug is prevented from being uncoupled from the power receptacle, wherein the door and the housing are configured to at least partially encapsulate the external plug when the door is in the second position, and wherein the door is configured to receive a separate locking device configured to secure the door in the second position.
